(19) United States
(12) Patent Application Publication
(10) Pub. No.: US 2017/0226812 A1
(43) Pub. Date: Aug. 10, 2017

(54) METHOD AND APPARATUS FOR DECONTAMINATION OF WELL DRILLING AND FRACTURING FLUID

(71) Applicant: MICHAEL P. NICHOLS, Port Lavaca, TX (US)

(72) Inventor: MICHAEL P. NICHOLS, Port Lavaca, TX (US)

(21) Appl. No.: 15/017,648

(22) Filed: Feb. 7, 2016

(51) Int. Cl. E21B 21/06; B09B 3/00

(52) U.S. Cl. CPC E21B 21/066; B09B 3/0083; E21B 43/26

(57) ABSTRACT

A thermo-chemical bio-reactor process and apparatus for decontaminating waste well drilling fluid and waste formation fracturing fluid. A roller supported power driven rotary drum is rotated about a horizontal axis and receives waste well fluid from a hopper that conveys the waste fluid into an inlet end of the rotary drum. A burner within the rotary drum is fired by a gaseous fuel and a gaseous oxidizer and develops sufficient heat to render the waste material to a dry and substantially chemically inert finely pulverized residue during transit through the rotary drum. Angulated waste agitation vanes are positioned in helically oriented arrays within the rotary drum to lift the waste material and cause it to descend through heat and flame within the rotary drum and to be conveyed to the outlet of the drum during processing.

### RELATED PATENT APPLICATION

Applicant hereby claims the benefit of U.S. Provisional Patent Application No. 62/113,488, filed on Feb. 8, 2015 by Michael Nichols for an invention entitled “Method and Apparatus For Decontaminating Frack Fluid”, which Application and its subject invention are incorporated herein by reference for all purposes.

### BACKGROUND OF THE INVENTION

Field of the Invention

The present invention relates generally to the drilling of wells for production of petroleum products and to processes and apparatus for pressure fracturing subsurface production formations to enhance the production of crude oil and natural gas therefrom. More specifically, the present invention involves a method and apparatus for decontaminating well drilling fluid and formation fracturing fluid that results from well drilling and completion activities, thus minimizing the need for expensive fluid transportation and disposal activities. Even more specifically, the present invention provides for treating of well drilling and well fracturing fluid at sites at or near wells being drilled and processed to achieve the production of useful products from a waste fluid that would otherwise be characterized as potentially harmful to the environment.

Description of the Prior Art

During recent years, the oil and gas field services industry, particularly in the United States, has had significant growth because the demand for domestically produced oil and gas products has dramatically increased. The United States of America is at the present time the world's largest consumer of petroleum products, accounting for approximately 22% of the world's total consumption. To provide an ample supply of petroleum to keep up with its consumption, the government and private sector is designating more land for oil exploration. In addition to conventional well drilling practices, formation fracturing techniques, also known as “fracking” are being employed to enhance production from wells. Subsurface oil and gas bearing formations are fractured by injection of fluid, sand and other constituents into the fractures of petroleum bearing subsurface formations under very high pressure, in essence propping the fractures to prevent them from closing. These fractures promote significant propagation of fluid and gas products through the formation structure. Improvements in well drilling techniques now permit deviated drilling by which a wellbore drilling apparatus can be steered during drilling to provide a substantially horizontal or angularly controlled bottom section that extends a distance laterally within a subsurface oil and gas bearing formation. The oil and gas bearing formation is then fractured and the fractures are propped by pumping a fluid into the wellbore that is laden with coarse sand and other materials to enhance the flow of petroleum products from the formation and into production tubing for flow to a wellhead. The wellhead then directs controlled production flow to a liquid/gas separator, with the separator discharge being to pipelines or storage tanks.

Subsurface fracking processes have been implemented to reach previously inaccessible oil and gas in the subsurface production formations and stimulate oil and gas production. Fracking is a prevalent technique used to access deposits of oil and natural gas particularly in shale deposits. In response to increased worldwide demand for transportation, fuel, and manufacturing, the petroleum industry is expected to expand exponentially during the immediate future.

The bi-products of conventional well drilling and fracking processes yields a waste product, typically in the form of slurry, which contains various contaminants such as sand, water and skim oil. The water, sand and skim oil slurry is often contaminated with harmful hydrocarbons, chlorides, lead, uranium, mercury, ethylene glycol, radium, methanol, hydrochloric acid, arsenic and other toxic chemical components that are incorporated within the well fluid that is used in a well drilling and/or formation fracturing process or is liberated from the subsurface formation material that is intersected by the wellbore. Well drilling fluid and well fracking fluid typically contain components that tend to form clumps or “balls” in the fluid after having been discharged from a well. If the waste fluid is then collected and injected into a disposal well, the clumps or balls will tend to “bridge” within the disposal well, at times damaging the disposal well to the point that it must be abandoned. It is therefore desirable to provide a system for treating such fluid in a manner that the waste fluid balls will be broken up and reduced to simple granular material during the fluid treating process. It is also desirable that the well fluid waste material be processed to a dry and substantially chemically inert form to that is may be disposed of in local landfills or that it be used in the manufacture of other useful products, such as concrete, for example, thus eliminating the need to transport the waste material long distances and employ the services of expensive hazardous waste disposal facilities.

Since the start of fracking operations, well drilling and completion operators have been able to, for a price, transport the fracking fluid to landfills or land farms and the water to disposal wells as long as it did not contain a high level of contaminates. Presently however, national and state regulatory bodies have determined that virtually all drilling and fracking waste fluid contains these very harmful contaminants and that there is significant risk that these contaminants can contaminate the ground and underground water sources. Consequently disposal of drilling fluid and fracking fluid at local disposal sites is being curtailed and significant fines and other government and industry penalties are being imposed if the fluid is not properly treated, handled and disposed of. At the present time the waste material from well drilling and well fracturing activities is transported by truck from well sites to designated disposal sites for hazardous wastes. It is not unusual for the waste material to be trucked several hours one way to designated disposal sites, adding considerable expense to well drilling and completion operations. There is a need therefore, for the development of a process for achieving decontamination of drilling fluid and fracking fluid at well and oil field sites so that virtually all of its harmful constituents will be destroyed or rendered substantially inert, without any risk of contamination of the atmosphere, the soil or the subsurface water. Moreover, it is well known that every oil company remains indefinitely liable for any soil and water contamination that results from a well drilling or formation fracking process. Accordingly, it is expected that many oil companies and drilling/completion contractors will readily pay a fee to have their drilling fluid and/or formation fracking fluid easily and efficiently decontaminated on site to avoid the costs of transportation and expensive hazardous waste disposal. Thus, it is deemed appropriate to have equipment that can be moved to a well drilling site or area on conventional roadways and is capable of treating the waste fluid and rendering it safe for conventional disposal and having a residue that is safe for use in other useful products.

### SUMMARY OF THE INVENTION

It is a principal feature of the present invention to provide a novel method and apparatus for achieving low cost decontamination of the fluid residue of well drilling and formation fracturing operations.

It is another feature of the present invention to provide a novel method and apparatus for decontaminating fracking fluid and converting the constituents thereof to harmless waste and commercially saleable products.

It is an important feature of the present invention to provide apparatus for decontaminating drilling fluid and fracking fluid and also being designed for transport over conventional roadways to well drilling sites and areas for efficient use during well drilling and completion and capable of movement to other well sites and areas as needed. This feature substantially eliminates the need for expensive transportation of the waste fluid to disposal sites for hazardous chemical material.

Since heat is employed in the waste fluid treatment process, it is another feature of the present invention to employ residual heat of the process to accomplish additional activities such as the reclamation of water as pure condensed water and to employ the heat for other processes, such as separation and recovery of various types of oil from the waste fluid for sale as useful products.

Briefly, the principal object and feature of the present invention concerns decontamination of drilling fluid and subsurface formation fracturing fluid, to eliminate the need for special handling and transportation processes for disposal of the fluid at designated waste disposal sites for hazardous chemical materials. Other objects and features of the present invention are realized through the provision of a cost effective and efficient technology to decontaminate the waste drilling or formation fracturing fluid and render its liquid content and residue for use in many different commercial areas. The potentially harmful water content can be turned into clean distilled water and purified well drilling products which can be sold back to the industry at very competitive rates. Petroleum industry organizations will pay to have the drilling and fracking fluid properly decontaminated on site, thus minimizing the long term liability that presently exists. This entire process and processing equipment is portable to the extent that it can be utilized at individual well sites or at close by regional decontamination facilities, dramatically decreasing the need for trucking the fluid to specifically designated sites that are certified for expensive disposal of hazardous chemical wastes. According to the present invention applicant has developed a method and apparatus for decontaminating the waste fluid products of well drilling and subsurface formation fracturing and for establishing commercial benefit via fluid decontamination services and by conversion of the waste fluid of well drilling activities into saleable products.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a schematic illustration showing a process and mobile apparatus for use at a well site or drilling area to accomplish decontamination of drilling fluid and formation fracturing fluid and producing a processed residue that is safe for disposal at any waste disposal site and safe for incorporation within other materials, such as concrete for example;

FIG. 2 is a side elevation view showing the discharge end section of a well drilling fluid decontamination mechanism constructed according to the principles of the present invention and embodying the process and apparatus shown schematically in FIG. 1 and further showing external heat controlling paneling;

FIG. 3 is an isometric illustration showing a side view of the drilling fluid and frack fluid decontaminating mechanism of FIGS. 1 and 2;

FIG. 4 is an isometric illustration showing the processed product discharge end of the drilling fluid and frack fluid decontaminating mechanism and its support and transport skid being positioned on a trailer for transportation and use;

FIG. 5 is an isometric illustration showing the drilling fluid and frack fluid decontaminating mechanism and its support skid positioned on a trailer and further showing cable and winch apparatus for raising the heat and gas discharge exhaust stack and lowering the stack to a substantially horizontal position for trailer transport to desired sites;

FIG. 6 is an isometric illustration showing an end portion of the drilling fluid and frack fluid decontaminating mechanism particularly showing the waste fluid receiving hopper thereof and showing the electric motor energized mechanism for rotating the waste processing drum and for moving the waste fluid from the hopper into the rotary waste processing drum;

FIG. 7 is an end view of the drilling fluid and frack fluid decontaminating mechanism of the present invention, showing the waste fluid receiving hopper and further showing the motor powered mechanism for rotating the waste processing drum and for feeding waste fluid from the hopper into the rotary waste processing drum;

FIG. 8 is an isometric illustration showing the drilling fluid and frack fluid decontaminating mechanism positioned on a trailer with its exhaust stack positioned substantially horizontally for roadway travel, and in greater detail showing the motor powered rotary drive mechanism for the rotary drum and waste fluid feed mechanisms and showing a hopper vibrator mounted to the hopper to facilitate movement of the waste fluid to the rotary feed mechanism for conveyance into the rotary waste processing drum;

FIG. 9 is a partial side elevation view showing the discharge end of the rotary waste processing drum and showing pivotal mounting of the exhaust stack to facilitate its pivotal movement from the substantially horizontal position that is shown to an upright position for operation of the drilling fluid and frack fluid decontaminating mechanism.

FIG. 10 is an end view of the rotary waste processing drum showing a plurality of internal angulated waste conveying vanes mounted within the drum and positioned in a plurality of substantially evenly spaced curved arrays;

FIG. 11 is another partial end view showing positioning of the internal angulated waste conveying vanes within the waste processing drum and emphasizing the waste conveying configuration of each of the vanes;

FIG. 12 is an isometric illustration showing one of the drum support roller and bearing assemblies mounted to the skid of the drilling fluid and frack fluid decontaminating mechanism and emphasizing roller and bearing cooling via a tubular bearing shaft and roller vent opening facilitating air circulation through the drum support roller and bearing assemblies;

FIG. 13 is an isometric illustration showing the machine operation and control housing of the drilling fluid and frack fluid decontaminating mechanism, including fuel and oxidizer distribution lines leading to one or more burners that are located within the rotary waste processing drum; and

FIG. 14 is an isometric illustration showing electrically actuated burner members being connected with fuel mixture gas lines and being positioned within the inlet end portion of the rotary waste processing drum, the fuel mixture gas lines being connected with the fuel and oxidizer distribution lines of FIG. 13.

### DETAILED DESCRIPTION OF PREFERRED EMBODIMENT

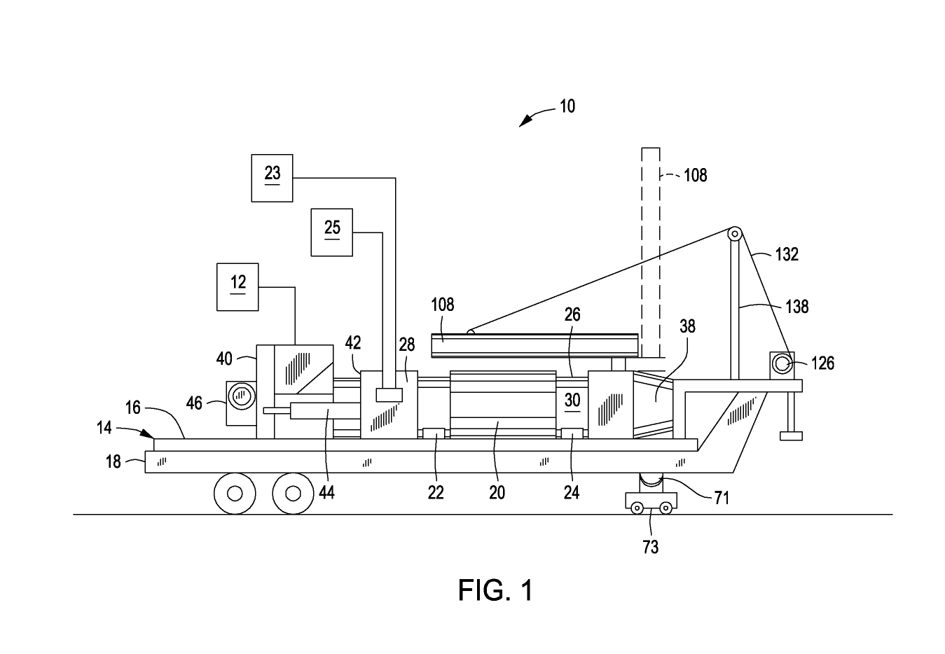

Referring now to the drawings and first to FIG. 1, there is shown a schematic illustration of a waste well fluid decontaminating process generally at 10 having a supply of waste drilling fluid or formation fracturing fluid 12 which is discharged from wells that are being drilled or which have been treated with a formation fracturing process. It should be borne in mind that the waste fluid typically includes sand, gravel, shale, rocks, concrete particles and the like and typically contains a wide range of chemical constituents that are used during well drilling and servicing activities. Apparatus for accomplishing decontamination of the well drilling or fracturing fluid, also referred to herein as a well fluid decontamination unit, is shown generally at 14 in FIG. 1 and includes a skid 16 on which the apparatus is mounted. For transport of the apparatus to well sites or oil fields, the skid 16 is typically positioned on a trailer 18 that is towed over standard roadways by a tractor or other vehicle, not shown. The width, height and other dimensions of the apparatus, when mounted on a trailer are within acceptable limits for conventional roadway travel.

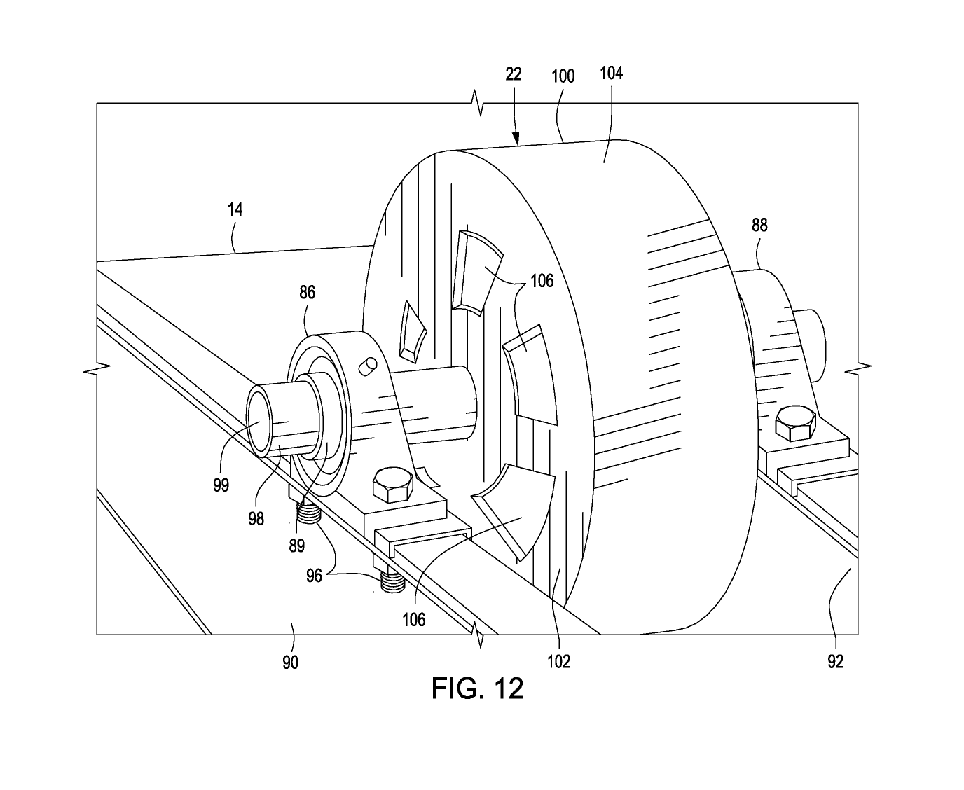

The apparatus 14, which is a thermo-chemical bio-reactor, includes a generally cylindrical drum 20 that is supported for rotary movement by means of a plurality of support roller assemblies, two of which are shown at 22 and 24 in FIG. 1. The roller assemblies typically have the form and function that is shown in FIG. 12, which is described in detail below, but may have any other form that is convenient for supporting a heavy rotary drum and permitting its rotation during high heat processing of the waste fluid for purposes of on-site decontamination. A supply 23 of flammable gas, such as propane, natural gas or any of a wide variety of flammable gases is mounted to the skid structure conducted into the inlet of the rotary waste processing drum 20. A supply 25 of an oxidizer gas, such as oxygen, also mounted to the skid structure 16 is introduced into the inlet of the rotary waste processing drum, the fuel and oxidizer gases being mixed to desirable proportion and being simultaneously conducted to one or more burners 58 that develop a desired flame for heating the waste material that is present within the rotary drum. The generally cylindrical rotary drum 20 has a generally cylindrical drum core 26 that is formed by a section of large diameter cylindrical pipe that is composed of steel or any other material that is capable of withstanding heat in the range of up to about 3,000° F. without becoming damaged. If desired, the internal cylindrical surface of the drum core may be covered with a heat resistant material that may be composed of any suitable metal or non-metal material. However, it has been proven by tests that steel pipe will withstand the temperature conditions that are prevalent within the rotary drum during extended operation of the apparatus. For external thermal protection, especially for the protection of workers near the apparatus and for retention of heat within the rotary drum 20, the cylindrical drum core 26 is provided with sections of external insulation 28 that cover most of the external cylindrical surface 30 of the cylindrical drum core 26, leaving small cylindrical sections of the drum core exposed for supported contact with the drum support roller assemblies 22 and 24. The layer of insulation material 28 typically has a thickness in the range of from 2″ to 5″, depending on the selected internal temperature of the heated gas within rotary drum. The insulation is secured in place by a plurality of retainer bands 29 that may be composed of stainless steel for weather and chemical resistance, but in the alternative may have the form of any other suitable thermal resistant metal or polymer material.

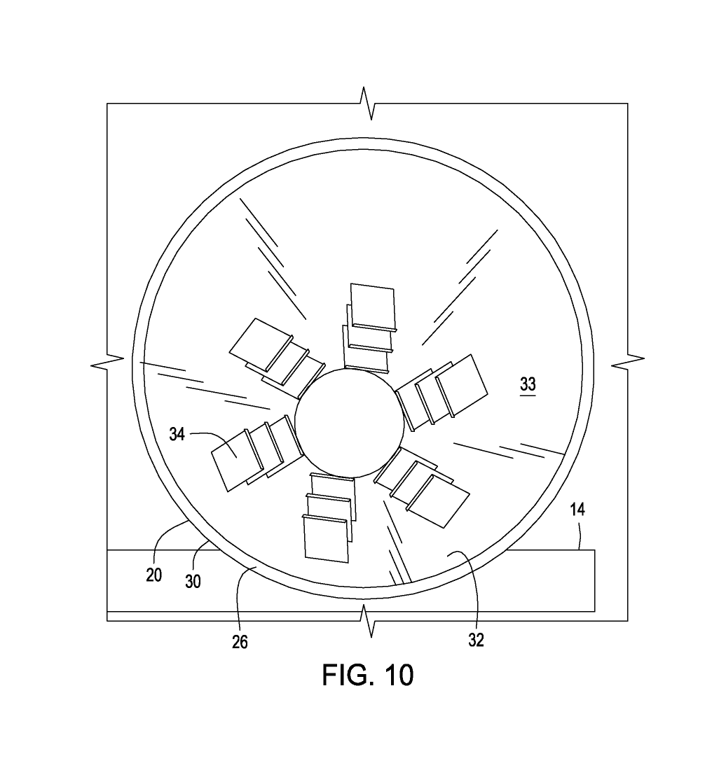

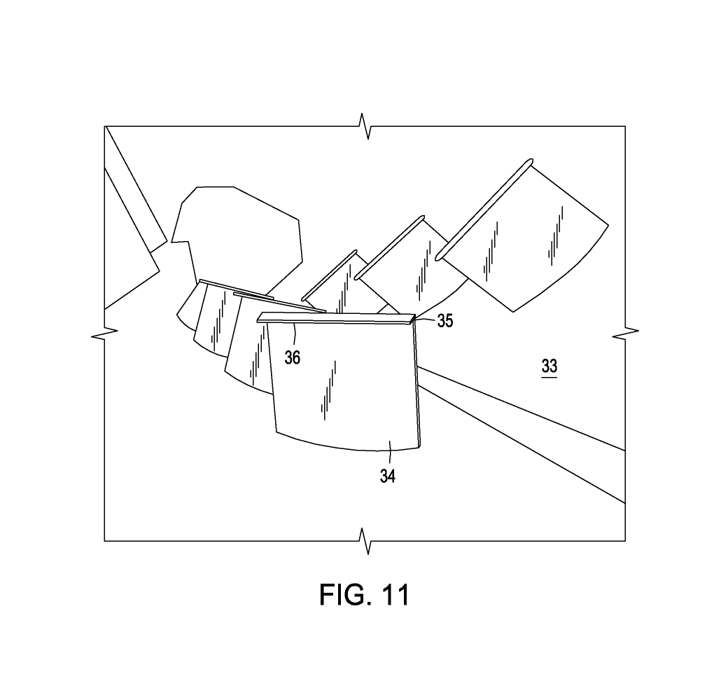

With reference to FIGS. 10 and 11, the generally cylindrical drum core 26 defines a generally cylindrical internal surface 32 defining a well fluid waste processing chamber 33 and having fixed to the generally cylindrical internal surface 32, such as by welding or any other suitable means for support and retention, a plurality of annularly spaced arrays of waste agitation and movement blades 34. Each of said waste agitation and movement blades defines a terminal end 35 that projects toward the axis of rotation of the generally cylindrical drum core 26. Preferably the arrays of waste agitation and movement blades are arranged in spiral fashion, with the blades each being angulated with respect to the horizontal center-line of the rotary drum so that each blade will impart components of rotary and linear movement to the well fluid waste material being processed, lifting the waste material within the rotary drum and releasing it near the top of the internal fluid waste processing chamber 33 to descend through hot gas within by gravity as well as propelling the waste material toward the discharge end of the rotary drum. The angulation of each of the waste agitation and movement blades is designed relative to the rotation speed of the rotary drum so that the waste material is completely processed by the time it reaches the discharge end of the rotary drum. Each of the waste agitation and movement blades 34 is provided with a laterally oriented waste lifting flange 36 at its terminal end that assists in retention of the waste material and transporting it upwardly within the internal waste processing chamber of the rotary drum and releasing it within the upper portion of the drum so that the fluid waste material will tend to be broken up by the impact of falling onto the waste agitation and movement blades 34 and onto the inner surface 32 of the drum. Since the waste drilling or fracturing fluid tends to form clumps or “balls” due to its liquid and solid constituents and the adhesive character of its liquid constituents, it is important that the waste fluid be agitated and subjected to impacts during processing so that the clumps or balls will be broken up and reduced to granular form for ease of residue disposal. Falling waste material within the rotary drum will impact other blades within the drum as well as impacting the bottom cylindrical surface of the drum. These impacts will break up the clumps or balls of waste material, so that it emerges at the discharge end 38 of the rotary drum as a rather fine pulverized residue that is completely dry and is substantially chemically inert. The residue can be disposed of in landfills or other conventional disposal facilities or it can be incorporated within other products such as concrete, for example, due to its substantially inert character.

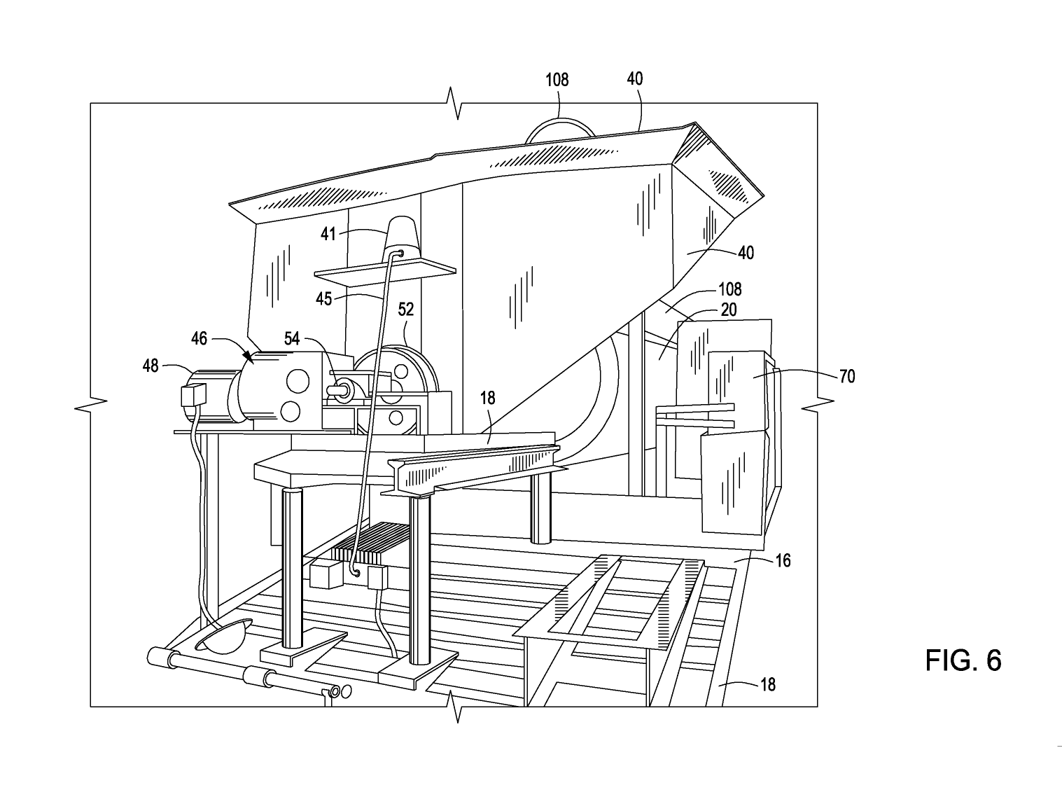

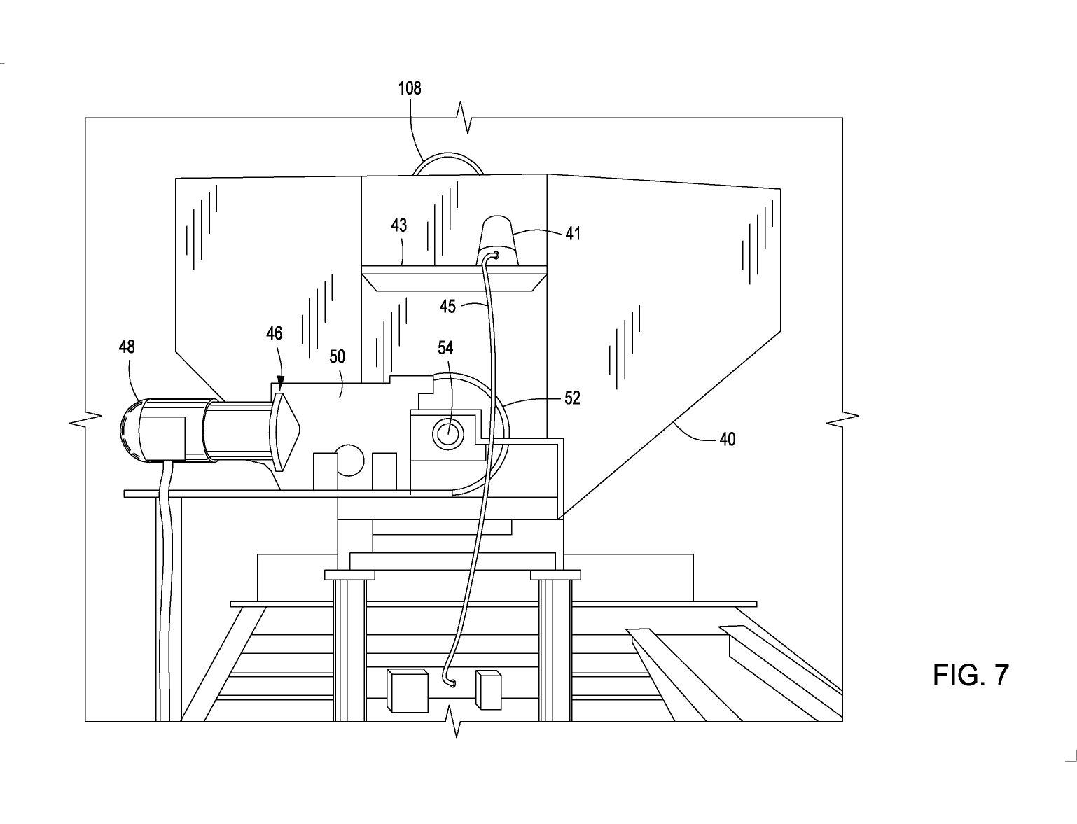

A waste fluid receiving and feeding hopper 40 is located adjacent the inlet end 42 of the rotary waste processing drum 20 is mounted to the skid structure 14. For the purpose of safety during roadway travel a safety light 41 is mounted to a support platform 43 as shown in FIG. 7 and has an electrical cord 45 that is connected with the electrical circuitry of the trailer. Preferably the safety light is a flashing light that alerts following vehicles to the presence of the waste processing unit. At its bottom portion the waste fluid receiving and feeding hopper 40 defines a bottom outlet 47 that is in communication with an inlet opening of a tubular waste feed housing 44 within which is located an auger that is rotated to feed fluid waste material from the hopper 40 into the rotary drum 20. The rotary drum and the auger are operated by a motor energized rotary drive mechanism identified generally at 46 and shown in greater detail in FIGS. 6-8. The motor energized rotary drive mechanism 46 has a motor 48 which is preferably an electric motor, though the motor may be of any suitable character that has a rotary output shaft. A transmission 50 is mounted to the skid 18 adjacent the waste receiving hopper 40 and has internal reduction gearing that is driven by the output shaft of the motor 48. The transmission drives a rotary output gear 52 that engages and imparts rotary movement to a drum and auger drive shaft 54 that rotates the waste processing drum and the waste feeding auger. If desired, however, the waste feeding auger may be operated by an auger drive shaft that is separately powered by the transmission 50 or is powered by drive gearing that is actuated by the drive shaft 54 of the rotary drum, especially if different rotational speeds are desired for the rotary drum and the rotary waste feed auger. Also, if desired, the rotary waste feeding auger may be operated by a separate output shaft of the transmission 50, thereby permitting the rotary drum and rotary auger to be operated at proportional rotational speeds.

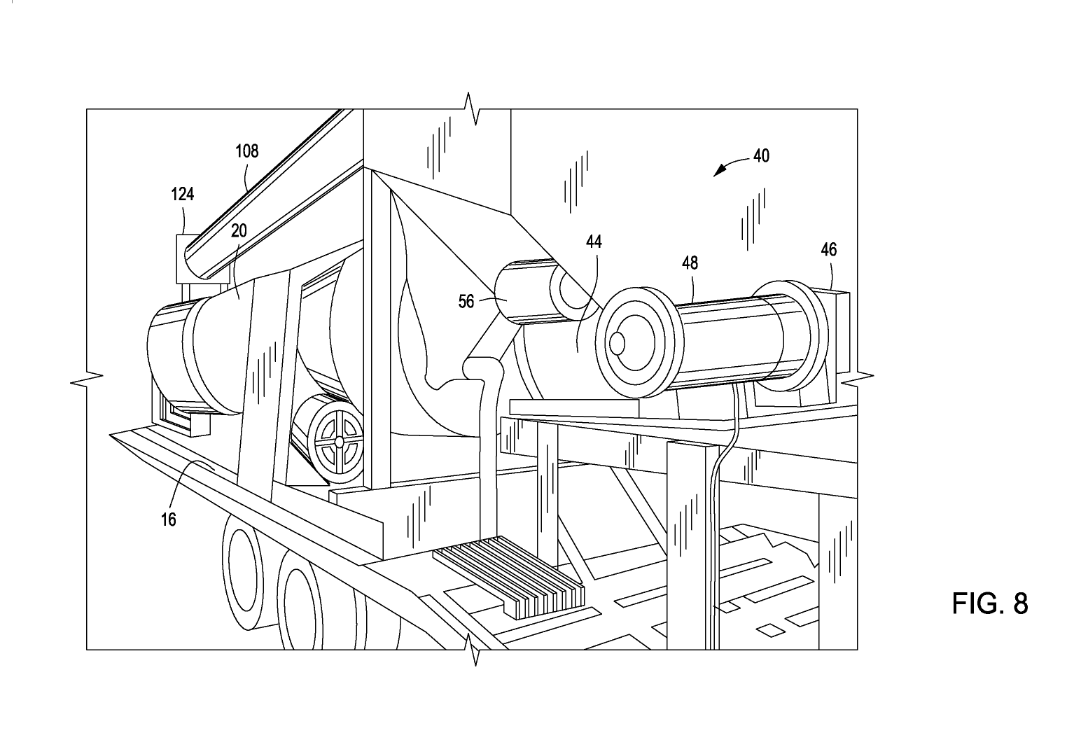

To enhance movement of the waste well fluid within the hopper 40, as shown in FIG. 8, a vibrator mechanism 56 is mounted to one of the wall panels, particularly a lower wall panel of the hopper 40. As the vibrator is operated the wall panel to which it is mounted and generally the entire hopper structure is subjected to vibration, causing downward movement of the waste material that is deposited within the hopper and preventing any bridging of the waste material within any part of the hopper or auger tube entrance regardless of its consistency. The hopper, depending on the consistency of the well fluid waste material being processed, may be provided with an internal stainless steel liner to ensure ease of movement of the waste material within the hopper.

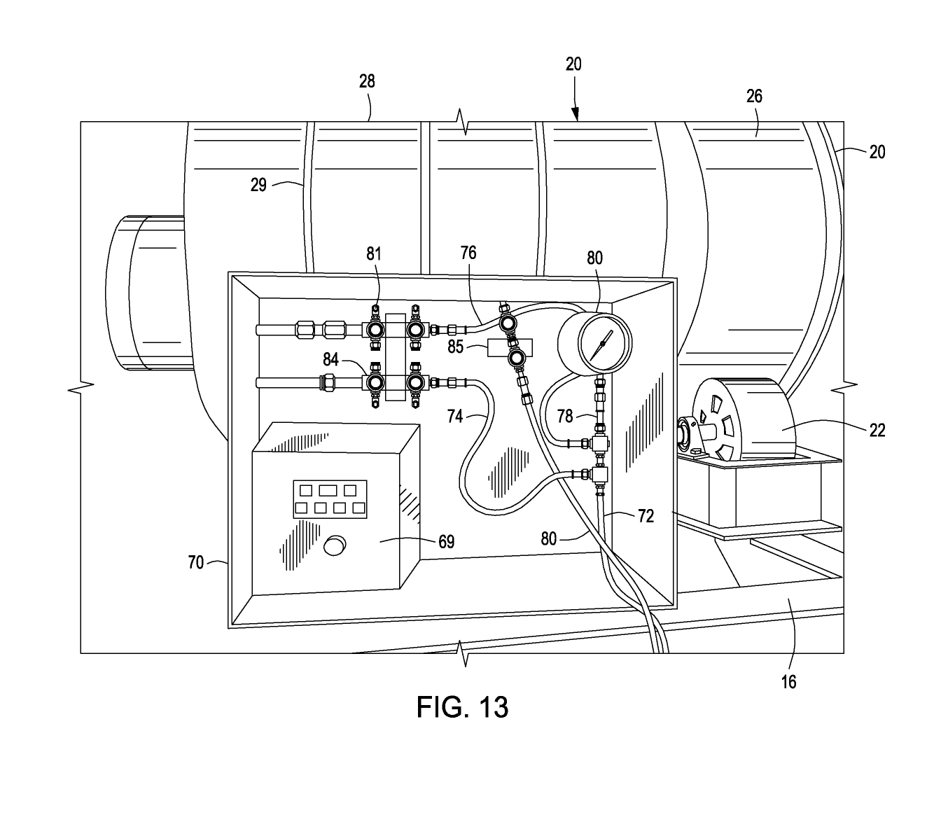

One or more burner members 58 are positioned within inlet end 42 of the rotary waste processing drum 20, each having a fuel gas mixture supply conduit 60 that is positioned within the drum inlet by means of a conduit hanger member 62 having a conduit opening or receptacle 64. Each burner member is provided with a spark plug 66 or any other suitable means for remotely controlled ignition of the fuel gas being caused to flow through the burner. The spark plug 66 is connected with an electrical burner ignition conductor 67 that extends to a burner control system 69 within a machine control console 70 shown in FIG. 13. Each burner member will typically be provided with air inlet openings 68 to assist with the fuel mixture feed to the burners. The fuel mixture is a combination of one or more flammable gases, such as propane, natural gas or the like with an oxidizer gas such as oxygen. The air inlet openings 68 of the burner members provide the burners with additional oxidizer gas. The fuel and oxidizer mixture, together with any flammable components within the waste fluid feed typically cause the temperature within the waste processing drum to reach 800° to 900° F. at the lower end of the temperature range and to reach from 2,000° to 3,000° F. at the higher end of the temperature range. At the discharge end of the rotary waste processing drum a residue discharge trough is positioned to receive the granular residue of the waste processing system. This granular residue is virtually inert so that it can be used as filler for concrete or other useful products that can be sold to the public. The residue can be deposited in a landfill or other convenient disposal facility without any possibility of being a contaminant. The granular residue is very hot as it drops from the residue discharge trough into a wheeled trolley or other suitable conveyance for safe storage or for movement to a safe site where the residue is permitted to cool to ambient temperature. The hot waste residue requires a considerable amount of time, perhaps a complete 24 hour period, to completely cool. Worker protection is needed to ensure that workers do not come into physical contact with the hot residue discharge until after the residue has cooled.

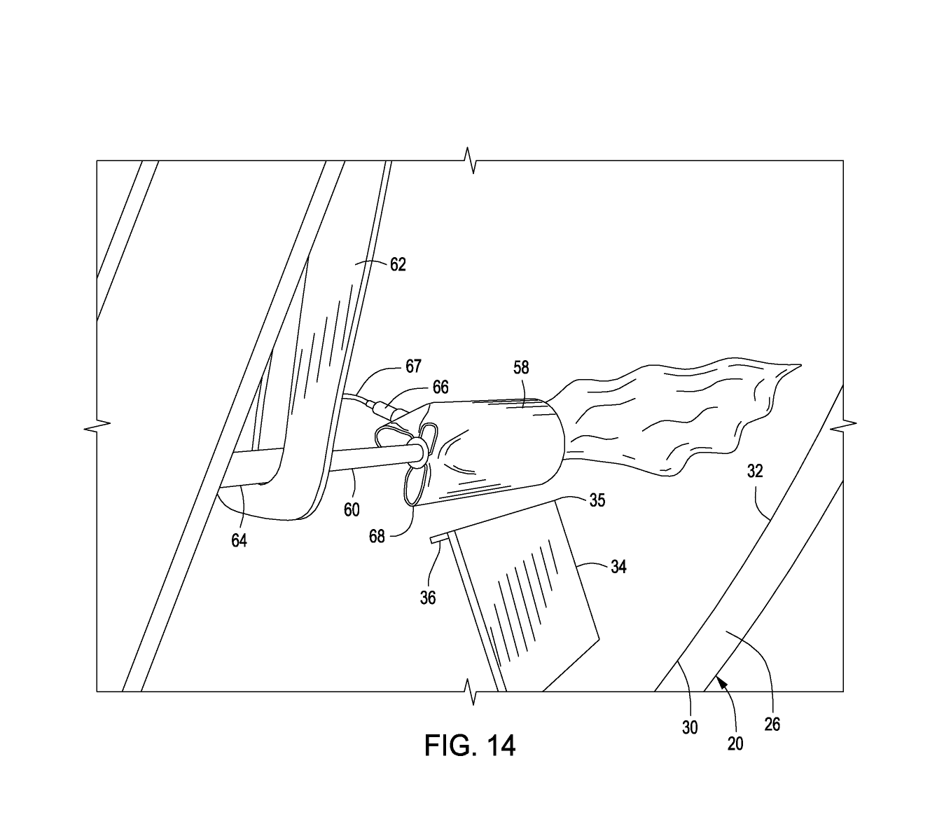

With reference to machine control system of FIG. 13, within the control console 70, in addition to the control box 69 with its electrical control circuitry there is provided a fuel oxidizer feed system providing fuel/oxidizer mixture to two burners of the nature shown at 58 in FIG. 14. The fuel/oxidizer mixture is supplied by a gas conductor 72 having burner supply conductors 74 and 76 and having a gas pressure conductor 78 connected with a pressure gauge, enabling the pressure of the fuel/oxidizer mixture to be selectively controlled for each of the burners. The fuel/oxidizer mixture lines are independently controllable via gas pressure control members 82 and 84 that are connected in the fuel/oxidizer mixture lines for the burners. A water supply line 83 is also positioned within the machine control console 70 to supply water to the internal chamber of the rotary waste processing drum. An adjustable water supply control valve 85 is mounted within the control console for adjusting the feed of water into the rotary waste processing drum according to conditions of the internal drum temperature and the character of the waste material being processed. When fed into the rotary drum the water is instantly transformed into steam and then vapor by the temperature conditions of normal processing operations. The steam serves as a cleaning agent to remove any residue buildup that might have accumulated within the rotary drum.

It is mentioned above that the rotary waste processing drum 20 is provided with rotary support by means of a plurality of drum support roller assemblies 22 and 24. Since the drum support roller assemblies are each in contact with the external cylindrical metal surface 30 of the generally cylindrical drum core 26 the drum support roller assemblies are subjected to considerable heat. For this reason the drum support roller assemblies are specifically designed to facilitate movement of air through the roller and roller bearing assemblies to ensure sufficient cooling of the roller components. As shown in FIG. 12 and other figures of the drawings one of the drum support roller assemblies is shown generally at 22 and has a pair of bearing assemblies 86 and 88 that are mounted to spaced cross members 90 and 92 of the skid structure 14 by means of retainer bolts 96. The bearing assemblies provide rotary support for a roller shaft 98 which provide support for a roller member 100. Though the roller shaft can be in the form of a solid metal shaft of cylindrical configuration, it is preferable to employ a tubular roller shaft to provide for cooling air circulation through the central opening or bore 99 of the roller shaft. The bearing assemblies 86 and 88 each retain bearing members 89 that receive the roller shaft 98 and may be of the lubricated variety if desired.

The roller member 100 is composed of steel or other temperature resistant metal or non-metal material and defines a pair of generally parallel side plates 102 having a center or axis of rotation with which the axis of rotation of the roller shaft is co-axially aligned. If desired, the roller shaft can take the form of a pair of axially aligned shaft sections that extend oppositely and co-axially from the side plates 102 of the roller member 100 thus permitting air circulation through the central passage of the shaft and into the hollow interior of the roller member 100. The cylindrical outer periphery of the roller member 100 is defined by a cylindrical wall member or drum contacting band 104 having its circular side edges connected with corresponding outer circular edges of the circular parallel side wall members 102. To further provide for cooling of the roller member 100 by means of ambient air circulation, the circular parallel side plate members 102 have a plurality of cut-outs 106 through which ambient air will flow for the purpose of transporting heat from the hollow drum support roller member. Each of the drum support rollers can have any suitable dimension that facilitates efficiency of rotational drum support. It has been determined, however, that drum support rollers having a diameter in the range of 12″ to 20″ will function well for this purpose. Tests have shown that drum support rollers having a diameter of about 16″ will serve quite satisfactory when the core of the rotary waste processing drum has a size in the range of between 40″ and 56″.

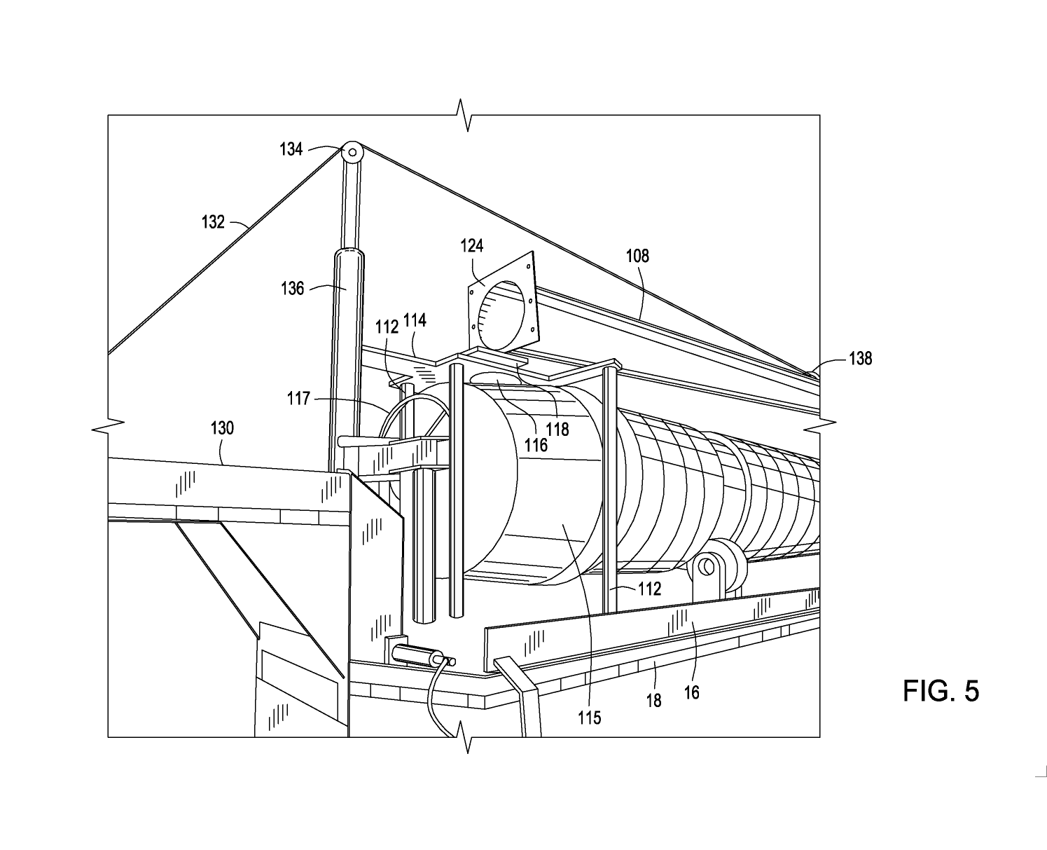

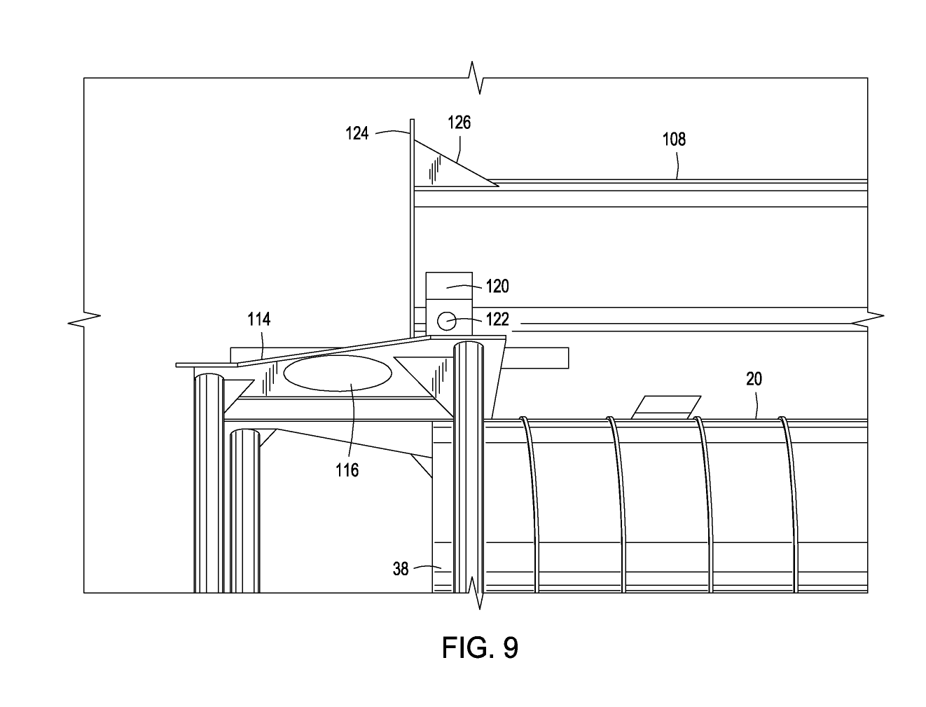

As mentioned above, the waste processing apparatus 10 has an exhaust stack 108 that is pivotally mounted to an exhaust stack support structure 110 so that it can be pivotally lowered to a substantially horizontal position as shown particularly in FIGS. 1-3 to permit travel of the drilling fluid and formation fracturing fluid waste treatment apparatus 10 over standard roadways without special permitting. As shown in FIGS. 5 and 9, upright support members 112 are mounted to and project upwardly from the skid structure 14 and provide support for a generally horizontal stack supporting platform 114. The platform 114 is composed of steel plate material, having an upwardly facing exhaust opening 116 that is in communication with the discharge end 38 of the rotary waste processing drum 20. An exhaust receiving housing 115 of generally conical configuration is supported to receive the gaseous exhaust output of the rotary waste processing drum 20 and to direct the flow of exhaust gas upwardly through the opening 116 of the plates 110 and 118 into the gas passage of the exhaust stack 108. A generally circular exhaust housing support 117 is mounted to support structure that is provided at one end of the skid structure and serves to maintain the position of the exhaust receiving housing 115. An exhaust stack mounting plate member 118 is secured to the generally horizontal stack supporting platform 114 and defines a plurality of bolt holes. A pair of pivot mount structures 120 are fixed to the stack supporting platform 114 and each defines a pivot opening receiving a pivot member 122 that is disposed in fixed relation with the stack structure 108 thus permitting the exhaust stack to be pivotally moveable between the upright position shown in broken line in FIG. 1 to the lowered substantially horizontal position shown the full line in FIG. 1. A stack retention plate 124 is mounted to the lower end of the exhaust stack 108 and is stabilized by a plurality of gusset members 126. The stack retention plate 124 is also provided with a plurality of bolt holes that match the bolt holes in the stack mounting plate 118 when the exhaust stack is positioned substantially vertically and its retention plate 124 is in face-to-face contact with the stack mounting plate 118. Retention bolts are inserted through the aligned bolt holes and serve to retain the exhaust stack at its upright operating position.

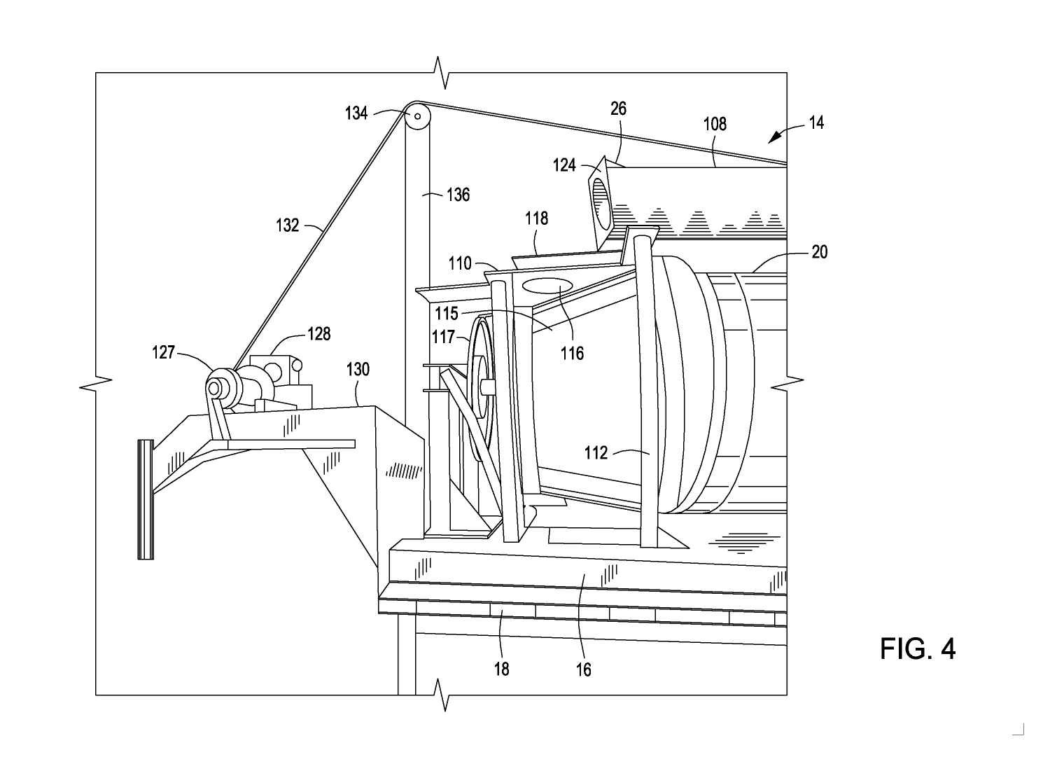

The exhaust stack may be pivotally raised and lowered by any suitable means; however as shown in FIGS. 4 and 5 a winch and positioning cable is employed to accomplish controlled pivotal movement of the exhaust stack between its horizontal and upright positions. In one suitable form of the invention a winch mechanism 127, powered by a motor and transmission 128 may be mounted on the tongue 130 of the trailer as shown in FIG. 4. Alternatively, the winch mechanism may be mounted to the skid structure so that it can be used when the skid is not positioned on the trailer 18. However, the trailer may be employed to successively transport different well fluid waste processing units to well sites and the trailer mounted winch mechanism can be used each time a waste processing unit is set up for use or taken down for movement to another site. A stack handling cable 132 of the winch mechanism 126 extends over a rotatable pulley member 134 that is supported at the upper end of a pulley positioning member, which may conveniently have the form of a cable positioning mast 136 that is of sufficient height to establish desired leverage for lifting of the exhaust stack to its upright position. The stack handling cable 132 is secured to a cable connector member 138 and due to the height of the cable positioning mast 136 is oriented at a sufficient angle relative to the substantially horizontally oriented exhaust stack 108 to achieve raising of the exhaust stack to its upright position. After the stack retention plate 124 has been released from the stack mounting plate 118, the winch and cable will be employed to pivotally lower the exhaust stack to its substantially horizontal position for roadway travel of the waste processing unit.

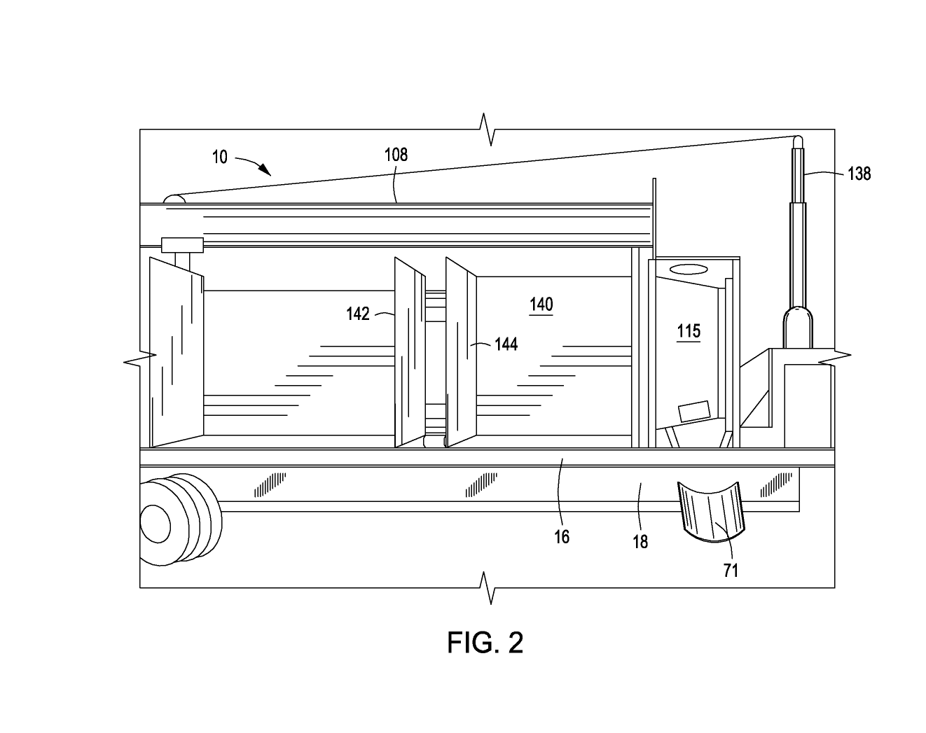

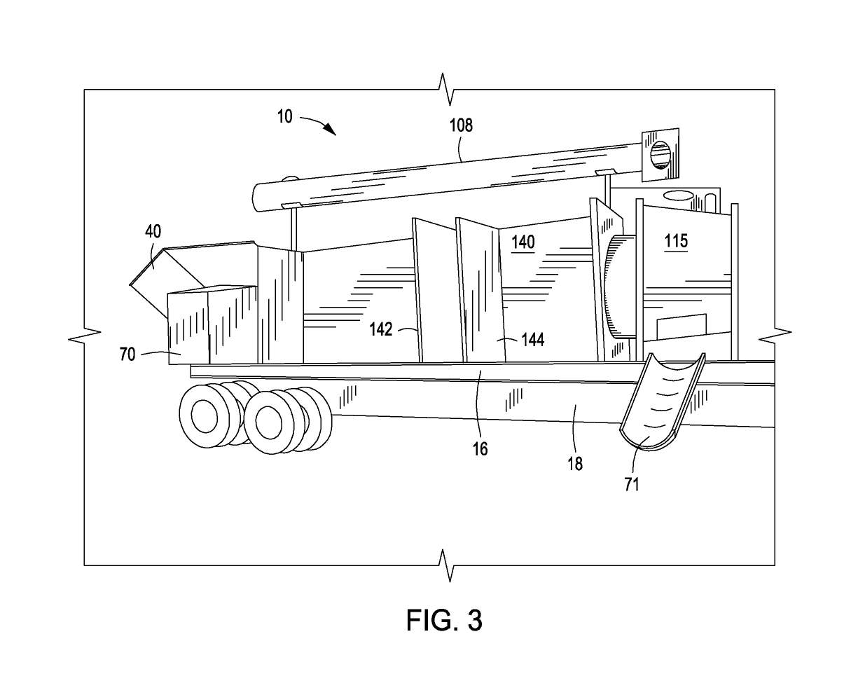

For purposes of heat control, with reference to FIGS. 2 and 3, external panels 140 are secured to the skid structure and are oriented substantially vertically. Heat liberated from the rotary waste processing drum 20 will be directed upwardly to provide for a more pleasant atmosphere for workers that might be near the waste processing unit. At each side of the non-insulated portions of the drum core there are provided substantially vertically mounted heat control panels 142 and 144 that are positioned in substantially perpendicular relation with the external panels 140. The external heat control panels 140, 142 and 144 are preferably composed of stainless steel for weather resistance, but if desired may be composed of any other suitable metal or non-metal material that is useful for the intended purpose.

Operation

The well fluid waste decontamination unit 10 is typically placed on a trailer such as shown at 18 and with its exhaust stack 108 lowered to its substantially horizontal travel position, the trailer and unit will have a proper size for travel over a conventional roadway without requiring special permits. After the well fluid waste decontamination unit 10 has arrived at the desired site the winch mechanism 126 will be energized causing rotation of the winch reel and applying force to the cable 132, causing pivotal lifting of the exhaust stack 108 to its upright position as shown in broken line in FIG. 1. With the exhaust stack so positioned, the plate members 118 and 124 will be positioned in face to face engagement and the bolt holes of the plates will be positioned in registry. The retainer bolts will then be inserted through the aligned bolt holes and tightened, thereby securing the plate members 118 and 124 together and retaining the exhaust stack in its substantially vertical position.

A machine operator present at the control console will start rotation of the rotary waste processing drum and with the spark plug igniters energized will introduce fuel and oxidizer into the waste processing drum via the burners, causing a flame of the burners to be injected into the rotary drum. Adjustments will then be made to the fuel and oxidizer supplies to tailor the flame of the burners to have the desired character for decontamination of the well fluid waste material.

With the waste decontamination unit in proper operation from the standpoint of flame generation, waste material is deposited into the hopper 40 with the hopper vibrator 56 energized to enhance downward movement of the waste material within the hopper to the auger housing 44 where it is forced into the rotary waste processing drum 20 by rotation of the auger. The waste processing drum 20 is then rotated at a desired speed to cause the agitation vanes 34 to lift the waste material due to drum rotation and to release the waste material near the upper portion of the internal chamber of the drum so that the waste material is caused to fall from the multiple agitation vanes and to impact other vanes as well as the inner surface 42 of the drum core 26. As the waste material, which can initially be in the form of a particulate containing slurry enters the rotary drum its water content is largely reduced to steam and vapor, thus causing the weight of the waste material to immediately decrease. The steam and water vapor exit the rotary drum 20 by means of the exhaust stack 108 at the discharge end of the rotary drum. As the clumps or balls of waste material impact the agitation vanes and the inner surface of the drum any clumps or balls of waste material will be broken up and quickly reduced to particulate form. The end flanges 36 of the agitation vane members function to ensure lifting of the waste material to the upper portion of the internal chamber of the rotary drum 20 so that the waste material will fall from a significant height within the drum and will be broken up by the impacts that occur. Any chemical content of the waste material will be decontaminated by the heat and agitation that takes place within the drum.

As the rotary drum is operated, the angulated spiral arrays of agitation vanes will cause the waste material to be moved toward the discharge end of the drum, where it falls into the discharge chute 71 and descends into a trolley member 73 or any other suitable receptacle

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A thermo-chemical bio-reaction process for decontamination of waste drilling fluid mixture or waste well fracturing fluid mixture that results from wells being drilled or wells being subjected to subsurface formation fracturing and containing water, oil and chemical constituents, said process comprising:
receiving the waste fluid mixture within a hopper and conveying the waste fluid from said hopper into the inlet portion of a rotary drum being rotated about a substantially horizontal axis;
developing a flame within the inlet portion of said rotary drum by mixing a fuel gas and an oxidizer gas and igniting the fuel and oxidizer gas mixture within a burner, said flame developing temperature conditions within said rotary drum sufficient to convert water to steam and water vapor to burn away any oil and to render any chemical constituents substantially inert;
agitating the waste fluid material within the rotary drum;
conveying the waste fluid material from said inlet portion of said rotary drum to a discharge portion of said rotary drum, said conveying having sufficient time duration to complete said waste processing and yield a substantially inert and completely dry residue; and
discharging the substantially inert and completely dry residue from said rotary drum to a residue receiving receptacle.

2. The process of claim 1, comprising:
said agitating being lifting the waste fluid material from a lower portion of said rotary drum to an upper portion of said rotary drum; and
releasing the waste fluid material to descend by gravity from the upper portion of said rotary drum to the lower portion of said rotary drum and be subjected to impact causing fracturing as the waste fluid material strikes internal structure within said rotary drum.

3. The process of claim 1, comprising:
said agitating being lifting the waste fluid material within said rotary drum by a plurality of agitation vane members mounted to the inner surface of said rotary drum and releasing the waste fluid material within the upper portion of said rotary drum, causing the waste fluid material to descend through flame and heat within said rotary drum and impact agitation vane members and the lower surface of said rotary drum with sufficient force to fracture the waste fluid material to a fine particulate form.

4. The process of claim 1, comprising:
said conveying the waste fluid material being engaging the waste fluid material with waste agitating vanes each projecting from the internal wall surface of the rotary drum being oriented in angular relationship with the axis of rotation of said rotary drum, said angular relationship being sufficient relative to the speed of rotation of said rotary drum that processing time within said rotary drum is sufficient to cause said waste fluid material to be converted to a dry fine particulate that is substantially inert and suitable for disposal in landfills and for use in other products.

5. Apparatus for thermo-chemical bio-reaction decontamination of waste well fluid from well drilling or well fracturing activities containing contaminants including water, oil and chemical constituents, comprising:
a support structure;
a rotary waste processing drum defining an inlet end and a discharge end and having an inner surface and an axis of rotation oriented substantially horizontally;
a plurality of roller assemblies being mounted to said support structure and having roller members disposed in supporting rotational engagement with said rotary waste processing drum;
a power actuated drive mechanism being connected in rotary driving relation with said rotary drum;
a waste fluid feed hopper being positioned to receive waste well fluid and to convey the waste fluid into said inlet end of said rotary drum;
a burner being located within said inlet end of said rotary drum and being connected with a gaseous fuel supply and a gaseous oxidizer supply and developing sufficient heat within said rotary drum to convert said water content of the waste fluid to steam and water vapor, to burn away any combustible content of the waste fluid and to render any chemical content of the waste fluid substantially inert; and
a plurality of waste agitation vanes being mounted to said inner surface of said rotary drum and during rotation of said rotary drum causing lifting and dropping of said waste fluid material within said rotary drum and propelling said waste fluid material to said outlet end of said rotary drum for discharge.

6. The apparatus of claim 5, comprising:
said rotary drum having a longitudinal axis about which said rotary drum is rotatable; and
said plurality of waste agitation vanes each being oriented in angular relation with said longitudinal axis, said angular orientation causing movement of waste fluid material being treated via a sufficient time period that said waste fluid material is completely processed as it reaches said discharge end of said rotary drum.

7. The apparatus of claim 5, comprising:
each of said waste agitation vanes having a flange member extending laterally therefrom, said flange members causing retention of said waste fluid material until the waste fluid material has been lifted to the upper portion of said internal chamber of said rotary drum, causing it to fall from a significant height and to impact other waste agitation vanes and the bottom surface of said rotary drum with sufficient force to be fractured.

8. The apparatus of claim 5, comprising:
said rotary waste processing drum having a generally cylindrical metal core having a generally cylindrical internal surface defining a well fluid waste processing chamber;
said plurality of waste agitation vanes each being fixed to said generally cylindrical surface and projecting toward said axis of rotation of said rotary waste processing drum and being oriented in angular relation with said axis of rotation, said plurality of waste agitation vanes each defining a terminal end projecting toward said axis of rotation; and
a terminal flange projecting laterally from said terminal end of each of said plurality of waste agitation vanes and serving to transport waste fluid material to the upper portion of said well fluid waste processing chamber and release the waste fluid material so that it descends through heated gas within said well fluid waste processing chamber and is broken up by striking said waste agitation vanes and striking said internal cylindrical surface.

9. The apparatus of claim 5, comprising:
said support structure having a roller support member;
each roller assembly having a drum supporting roller having an outer substantially cylindrical surface disposed in rotary supporting engagement with said rotary waste processing drum and having roller shafts projecting laterally therefrom; and
bearing members mounted to said roller support member and providing rotatable support for said roller shafts and providing for rotation of said drum supporting roller responsive to rotation of said waste processing drum;

10. The apparatus of claim 9, comprising:
said roller member having a generally cylindrical metal panel defining said outer substantially cylindrical surface and having generally circular side edges;
a pair of spaced roller side panels being disposed in substantially parallel relation and having circular outer edges being fixed to said generally circular side edges of said generally cylindrical metal panel, generally cylindrical metal panels and said spaced roller side panels defining a hollow roller structure having an internal air circulation chamber; and
said roller shaft projecting laterally from each of said pair of spaced roller side panels and being received by said bearing members.

11. The apparatus of claim 10, comprising:
said pair of spaced roller side panels each defining a plurality of air circulation openings; and
said roller shaft being of tubular form and having air circulation communication with internal air circulation chamber.

12. The apparatus of claim 11, comprising:
said roller shaft being defined by a pair of tubular roller shaft sections each being fixed to one of said pair of spaced roller side panels and projecting outwardly therefrom, said tubular shaft sections each having an air circulation passage being open to said internal air circulation chamber and open to the atmosphere.

13. The apparatus of claim 5, comprising:
said waste fluid feed hopper having tapered walls permitting waste fluid material deposited therein to descend to a hopper outlet; and
a vibrator mechanism having vibration inducing relation with said waste feed hopper and assisting in downward movement of the fluid waste material within said waste feed hopper and preventing bridging of the fluid waste material within said waste feed hopper.

14. The apparatus of claim 5, comprising:
an exhaust receiving housing being supported about said discharge end of said rotary waste processing drum and
a stack support platform being mounted to said support structure and having a pair of pivot mount members and defining an opening in communication with said exhaust opening of said exhaust receiving housing; and
an exhaust stack being pivotally mounted to said pair of pivot mount members and having a stack retention plate being disposed in face-to-face relation with said stack support platform when said exhaust stack is oriented substantially upright; and stack retaining members securing said stack retention plate to said stack support platform to maintain said exhaust stack substantially upright and being releasable from said stack support platform and said stack retention plate to permit pivotal lowering movement of said exhaust stack about said pivot mount members to a substantially horizontal position for roadway travel.

15. The apparatus of claim 14, comprising:
a pulley positioning member supporting a rotatable pulley at an elevated position relative to the substantially horizontal position of said exhaust stack;
a cable member engaging said rotatable pulley and having connection with said exhaust stack; and
a winch device having force transmitting relation with said cable member sufficient to pivotally raise said exhaust stack from said substantially horizontal position to said upright position for use of said apparatus.

16. Apparatus for thermo-chemical bio-reactive decontamination of waste well fluid from well drilling or well fracturing activities containing contaminants including water, oil and chemical constituents, comprising:
a support structure for transporting said apparatus to a well site;
a rotary waste processing drum defining an inlet end and a discharge end and having an inner surface and an axis of rotation oriented substantially horizontally;
a plurality of roller assemblies being mounted to said support structure and having hollow roller members disposed in supporting rotational engagement with said rotary waste processing drum, said hollow roller members having air circulation openings;
a power actuated drive mechanism being connected in rotary driving relation with said rotary drum;
a waste fluid feed hopper being positioned to receive waste well fluid and having an auger housing containing an auger member that is rotated to convey the waste fluid material from said waste fluid feed hopper into said inlet end of said rotary drum;
a burner being located within said inlet end of said rotary drum and being connected with a gaseous fuel supply and a gaseous oxidizer supply and developing sufficient heat within said rotary drum to convert said water content of the waste fluid to steam and water vapor, to burn away any combustible content of the waste fluid and to render any chemical content of the waste fluid substantially inert;
a plurality of waste agitation vanes being mounted to said inner surface of said rotary drum and during rotation of said rotary drum causing lifting and dropping of said waste fluid material within said rotary drum and propelling said waste fluid material to said outlet end of said rotary drum for discharge;
an exhaust receiving housing being supported about said discharge end of said rotary waste processing drum and receiving processed gas from said rotary drum;
a stack support platform being mounted to said support structure and having a pair of pivot mount members and defining an opening in communication with said exhaust opening of said exhaust receiving housing; and
an exhaust stack being pivotally mounted to said pair of pivot mount members and having a stack retention plate being disposed in face-to-face relation with said stack support platform when said exhaust stack is oriented substantially upright; and stack retaining members securing said stack retention plate to said stack support platform to maintain said exhaust stack substantially upright and being releasable from said stack support platform and said stack retention plate to permit pivotal lowering movement of said exhaust stack about said pivot mount members to a substantially horizontal position for roadway travel.

17. The apparatus of claim 16, comprising:
a pulley positioning member supporting a rotatable pulley at an elevated position relative to the substantially horizontal position of said exhaust stack;
a cable member engaging said rotatable pulley and having connection with said exhaust stack; and
a winch device having force transmitting relation with said cable member sufficient to pivotally raise said exhaust stack from said substantially horizontal position to said upright position for use of said apparatus.

18. The apparatus of claim 16, comprising:
said support structure having a roller support member;
each roller assembly having a drum supporting roller having an outer substantially cylindrical surface disposed in rotary supporting engagement with said rotary waste processing drum and having roller shafts projecting laterally therefrom; and
bearing members mounted to said roller support member and providing rotatable support for said roller shafts and providing for rotation of said drum supporting roller responsive to rotation of said waste processing drum;

19. The apparatus of claim 18, comprising:
said roller member having a generally cylindrical metal panel defining said outer substantially cylindrical surface and having generally circular side edges;
a pair of spaced roller side panels being disposed in substantially parallel relation and having circular outer edges being fixed to said generally circular side edges of said generally cylindrical metal panel, generally cylindrical metal panels and said spaced roller side panels defining a hollow roller structure having an internal air circulation chamber; and
said roller shaft projecting laterally from each of said pair of spaced roller side panels and being received by said bearing members.

20. The apparatus of claim 19, comprising:
said pair of spaced roller side panels each defining a plurality of air circulation openings;
said roller shaft being of tubular form and having air circulation communication with internal air circulation chamber; and
said roller shaft being defined by a pair of tubular roller shaft sections each being fixed to one of said pair of spaced roller side panels and projecting outwardly therefrom, said tubular shaft sections each having an air circulation passage being open to said internal air circulation chamber and open to the atmosphere.
